(19) United States
(12) Patent Application Publication
(10) Pub. No.: US 2007/0191111 A1
(43) Pub. Date: Aug. 16, 2007

(54) SYSTEMS AND METHODS FOR MINING DATA FROM A GAME HISTORY FOR A GAMING SYSTEM

(76) Inventors: Craig J. Sylla, Round Lake, IL (US); Mark C. Pace, Palatine, IL (US); Chad A. Ryan, Henderson, NV (US); Dale R. Buchholz, Palatine, IL (US); Mark B. Gagner, West Chicago, IL (US)

Correspondence Address: SCHWEGMAN, LUNDBERG, WOESSNER & KLUTH/WMS GAMING, P.O. BOX 2938, MINNEAPOLIS, MN, 55402, US

(21) Appl. No.: 11/458,879

(22) Filed: Jul. 20, 2006

Related U.S. Application Data
(60) Provisional application No. 60/701,309, filed on Jul. 20, 2005.

(51) Int. Cl. A63F 13/00

(52) U.S. Cl. 463/43

(57) ABSTRACT

Systems and methods receive and analyze game history data to discover relationships in the data. The relationships may then be used to determine which game components are downloaded to a gaming machine or which actions are performed for a particular player. The game components may include banner content, advertising content, denomination data, pay table, language data, video content, audio content, episodic game data, and wagering game software.

### RELATED APPLICATIONS

This application claims priority under 35 U.S.C. 119(e) from U.S. Provisional Application Ser. No. 60/701,309 filed Jul. 20, 2005, which application is incorporated herein by reference.

This application is related to United States Patent Application publication number 2004/0166940 entitled “Configuration of Gaming Machines” and published Aug. 26, 2004, which is hereby incorporated by reference for all purposes.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, 2006, WMS Gaming, Inc.

### BACKGROUND

Gaming machines may be operated as a stand alone unit, or linked in a network of some type to a group of gaming machines. As technology in the gaming industry progresses, more and more gaming services are being provided to gaming machines via communication networks that link groups of gaming machines to a remote central server computer that provides one or more gaming services. As an example, gaming services that may be provided by the remote computer to a gaming machine via a communication network of some type include player tracking, accounting, cashless award ticketing, lottery, progressive games and bonus games. In addition, gaming machines are evolving into gaming platforms where the gaming services and game play options provided on the gaming machines may be dynamically configured. Thus, the number and type of game services and game play options offered on a particular gaming machine may vary with time.

A gaming entity may operate hundreds, thousands or tens of thousands of gaming machines. Since gaming is allowed in many locations throughout the world, casinos may have games distributed over a wide geographic area. Within casinos, the gaming machines may be connected via one or more dedicated networks. Servers are usually located in a backroom of the casino away from the casino floor.

Current techniques for initially loading, modifying or replacing game software in gaming machines are generally inconvenient, time-consuming, and expensive. In one technique, the entire gaming machine is disconnected from the central server and replaced with a new machine. This involves the shipment of machines to and from a gaming establishment and requires the services of an appreciable number of skilled and semi-skilled service personnel. The service personnel must identify the machines to be replaced, locate the machines on the gaming establishment floor, and then replace the existing machines with the new machines. In another technique, the media containing the software is replaced with new media containing the new software. Again, the service personnel must identify the machines to receive the new software media, locate the machines on the gaming establishment floor, and then replace the existing media with the new media. In this case, media may be a hard disk, flash, various non-volatile media such as EEPROM, EPROM, etc.

In yet another technique, the new software can be downloaded to the gaming machine from the central server linked to the gaming machine. This downloading technique facilitates modifications to the game software in that it does not require removal of the gaming machine and does not require service personnel to visit the gaming machine site or the gaming machine itself. However, managing gaming machines that can receive downloaded software and data can be a problem. Determining which software and data belongs on which gaming machine can be a daunting task, especially in a gaming establishment with numerous gaming machines, or in environments where numerous gaming machines exist across multiple gaming establishments. The complexity of the problem and the number of potential configurations increases rapidly with the number of gaming machines that can receive downloadable software and data, and the number of downloadable components that may be installed on the gaming machine. The determination can be important, because of the impact an optimal selection of game component can have on the revenue generated by a gaming establishment.

### SUMMARY

The above-mentioned shortcomings, disadvantages and problems are addressed by the present invention, which will be understood by reading and studying the following specification.

Systems and methods receive and analyze game history data to discover relationships in the data. The relationships may then be used to determine which game components are downloaded to a gaming machine or which actions are performed for a particular player. The game components may include banner content, advertising content, denomination data, pay table, language data, video content, audio content, episodic game data, and wagering game software.

The present invention describes systems, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a perspective view of a gaming machine according to an example embodiment.

FIG. 2 is a block diagram of processing components of a gaming machine according to an example embodiment.

FIG. 3 is a block diagram of major software game components of a gaming machine according to an example embodiment.

FIG. 4 is a block diagram of a network of gaming machines and systems according to an example embodiment.

FIG. 5 is a block diagram illustrating game history data according to an example embodiment.

FIGS. 6A and 6B are flowcharts illustrating methods of managing downloads of game components to gaming machines in the network of FIG. 4.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The description of the various embodiments is to be construed as exemplary only and does not describe every possible instance of the invention. Numerous alternatives could be implemented, using combinations of current or future technologies, which would still fall within the scope of the claims. The following detailed description is, therefore, not to be taken in a limiting sense, and the scope of the present invention is defined only by the appended claims.

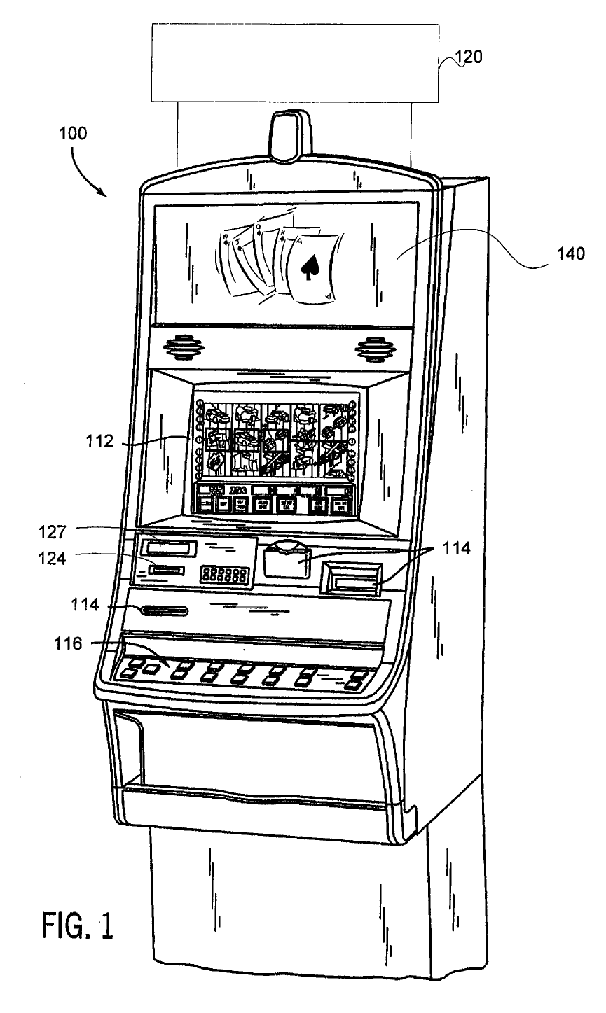

FIG. 1 illustrates an example gaming machine 100 in which may be included various embodiments of the invention. In some embodiments, gaming machine 100 is operable to conduct a wagering game. These wagering games may include reel based wagering games such as mechanical or video slots, card based games such as video poker, or other types of wagering games such as video keno, video bingo or a video dice game. If based in video, the gaming machine 100 includes a video display 112 such as a cathode ray tube (CRT), liquid crystal display (LCD), plasma, or other type of video display known in the art. In the illustrated embodiment, the gaming machine 100 is an “upright” version in which the display 112 is oriented vertically relative to a player. Alternatively, the gaming machine may be a “slant-top” version in which the display 112 is slanted at about a thirty-degree angle toward the player. Further, the gaming machine may be a “bar-top” version in which the display is mounted horizontally in a bar top or table top. Still further, the gaming machine may be housed in a wall mounted or other vertically mounted cabinet.

The gaming machine 100 includes a plurality of possible credit receiving mechanisms 114 for receiving credits to be used for placing wagers in the game. The credit receiving mechanisms 114 may, for example, include a coin acceptor, a bill acceptor, a ticket reader, and a card reader. The bill acceptor and the ticket reader may be combined into a single unit. The card reader may, for example, accept magnetic cards and smart (chip) cards coded with money or designating an account containing money.

In some embodiments, the gaming machine 100 includes a user interface comprising a plurality of push-buttons 116, and other possible devices. The plurality of push-buttons 116 may, for example, include one or more “bet” buttons for wagering, a “play” button for commencing play, a “collect” button for cashing out, a help” button for viewing a help screen, a “pay table” button for viewing the pay table(s), and a “call attendant” button for calling an attendant. Additional game specific buttons may be provided to facilitate play of the specific game executed on the machine. A touch screen overlaying video display 112 may define touch keys for implementing many of the same functions as the push-buttons. Additionally, in the case of video poker, the touch screen may implement a card identification function to indicate which cards a player desires to keep for the next round. Other possible user interface devices include a keyboard and a pointing device such as a mouse or trackball.

In some embodiments, gaming machine 100 includes a top box 140. Top box 140 may contain a video display, a mechanical display, or a diorama display that supplements display 112. For example, the display in top box 140 may be a wheel such as a rotating wheel, mechanical dice, a board for a board game, or other such display.

A processor controls operation of the gaming machine 100. In response to receiving a wager and a command to initiate play, the processor randomly selects a game outcome from a plurality of possible outcomes and causes the display 112 to depict indicia representative of the selected game outcome. In the case of slots for example mechanical or simulated slot reels are rotated and stopped to place symbols on the reels in visual association with one or more pay lines. If the selected outcome is one of the winning outcomes defined by a pay table, the CPU awards the player with a number of credits associated with the winning outcome.

Gaming machine 100 may include a player tracking card reader 124. A player may be enrolled in the gaming establishment's player club and may be awarded certain complimentary offers as that player collects points on his player tracking account. The player inserts the player-tracking card into the reader, allowing the gaming establishment's player tracking server to record the player's wagering activity. The gaming machine 100 may also include a player tracking display 127 to be used with the player-tracking card and card reader 124.

In some embodiments, gaming machine 100 may include signage 120. Signage 120 may be a display device capable of displaying advertising, gaming information (e.g. type of game, denomination of game etc.) or other information to a player or potential player.

It should be noted that in some embodiments, the gaming machine 100 may be a portable or handheld gaming machine. In these embodiments, the portable or handheld gaming machine include some or all of user interface elements as described above, however the user interface elements may be scaled, adapted or formatted to fit within the housing of the portable or handheld gaming machine. Such handheld or portable gaming machines may include portable computers, PDAs (Personal Digital Assistants), cellular telephones or any other devices capable of processing a computerized method.

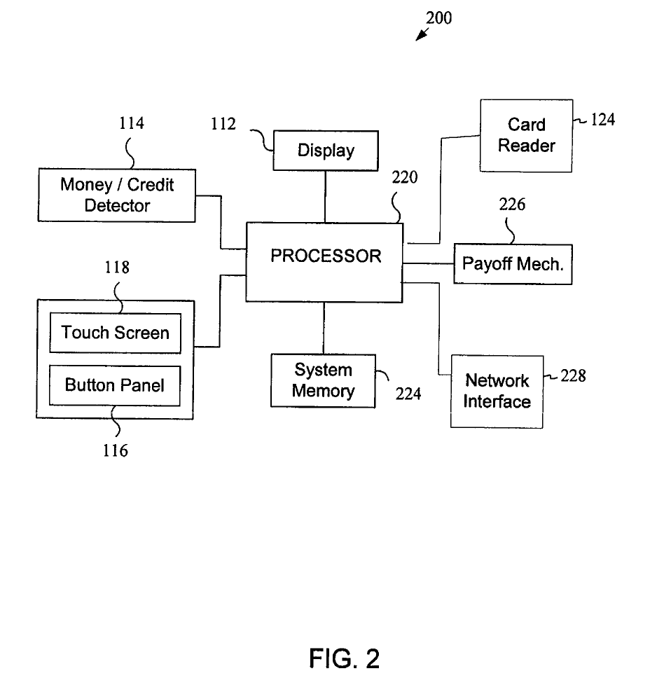

FIG. 2 is a block diagram of a control system 200 suitable for operating the gaming machine 100. Money/credit detector 114 signals a processor 220 when a player has inserted money, tickets, tokens, cards or other mechanism for obtaining credits for plays on the gaming machine through credit mechanisms 114. Using a button panel 116 and/or a touch screen 118, the player may select any variables associated with the wagering game and place his/her wager to purchase a play of the game. In a play of the game, the processor 220 generates at least one random event using a random number generator (RNG) and provides an award to the player for a winning outcome of the random event. Alternatively, the random event may be generated by a remote computer using an RNG or pooling schema and then transmitted to the gaming machine. The processor 220 operates the display 112 to represent the random event(s) and outcome(s) in a visual form that can be understood by the player. In addition to the processor 220, the control system may include one or more additional slave control units for operating the display 112 and any secondary displays.

System memory 224 stores control software, operational instructions and data associated with the gaming machine. In some embodiments, the system memory 224 comprises a separate read-only memory (ROM) and battery-backed random-access memory (RAM). However, it will be appreciated that the system memory 224 may be implemented on any of several alternative types of memory structures or may be implemented on a single memory structure. For example, memory 224 may comprise multiple banks of memory, including RAM, compact flash, hard drives, CD-ROM drives, DVD-ROM drives and combinations thereof.

A payoff mechanism 226 is operable in response to instructions from the processor 220 to award a payoff to the player. The payoff may, for example, be in the form of a number of credits. The number of credits is determined by one or more math tables stored in the system memory 224. As noted above with respect to FIG. 1, the payoff mechanism may be a coin hopper, a ticket printer, a magnetic card writer, or a database update mechanism that updates a database maintaining account information.

Network interface 228 operates to communicably couple system 200 in gaming machine 100 to a network. The network may be any type of wired or wireless network and the network interface 228 may vary based on the type of network. In some embodiments, the network comprises a gaming establishment network such as a LAN (local area network). In alternative embodiments, the network may be an intranet linking multiple networks, for example, the networks of a gaming enterprise that operates multiple gaming establishments. In further alternative embodiments, the network may comprise the Internet.

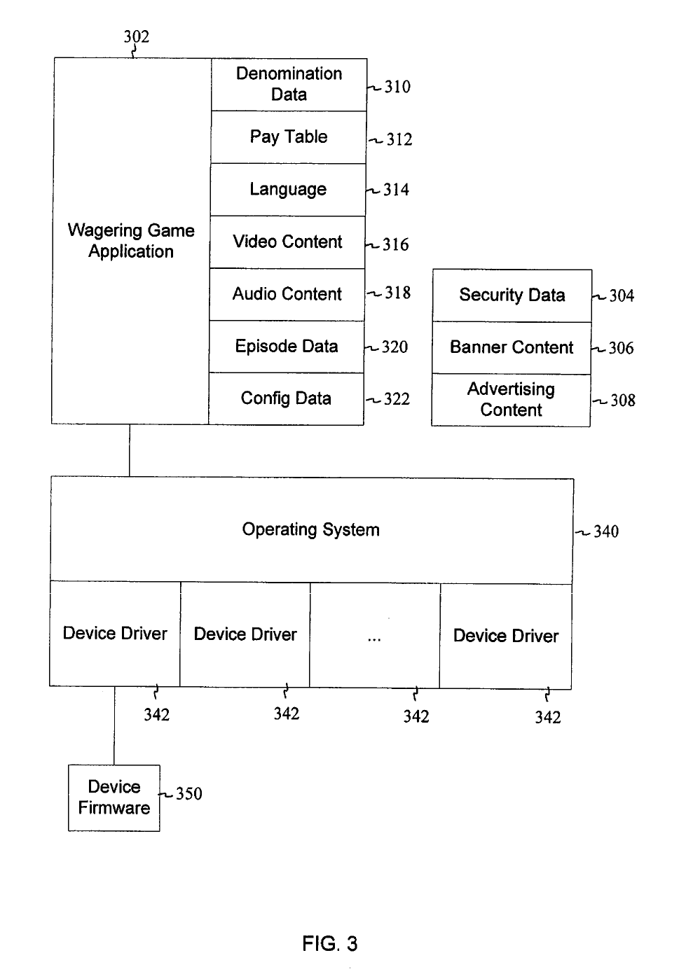

FIG. 3 illustrates various software game components (both executable and data) that may operate on a gaming machine 100. These components may comprise configuration elements for the gaming machine. In some embodiments, these components include wagering game application 302, game content and data 304-320, operating system 340, device driver 342 and device firmware 350.

Operating system 340 controls the execution of tasks, processes and applications (e.g. wagering game application 302) running on a gaming machine, and provides interfaces between applications and the hardware present on a gaming machine. The operating system may be proprietary to the gaming machine manufacturer or owner, or the operating system may be provided by a third party. Examples of operating systems that may run within the gaming machine environment include the Microsoft Windows family of operating systems, variants of the UNIX operating system, Linux, and real-time operating systems such as VRTX and QNX. The embodiments are not limited to any particular operating system.

Device driver 342 provides a software interface to hardware that may be present on a gaming machine and software that desires to utilize such hardware, such as a wagering game application 302. Typically a device driver is a software component that is added to the operating system software, and must be designed to provide interfaces expected by the operating system. A different device driver 342 typically exists for each type of hardware present on a gaming machine. For example, a ticket printer may have a device driver, a credit acceptor may have a different device driver etc.

Device firmware 350 comprises software that may be downloaded onto a persistent memory resident on a device that may be a component of gaming machine 100. For example, a ticket printer may include an embedded processor that executes software or reads data from firmware on a flash memory resident on the ticket printer. Other devices that are part of gaming machine 100 may also have firmware to control the operation and interface to the device.

Wagering game application 302 comprises software that controls the execution of a wagering game on gaming machine 100. For example, the wagering game application may provide a slot machine application (video or mechanical), keno, card based wagering games (e.g. poker), dice based wagering games or other types of wagering games. The embodiments are not limited to a particular wagering game application.

Wagering game 302 may include one or more data or executable components. These components include denomination data 310, pay table 312, language data 314, video content 316, audio content 318, episode data 320, and configuration data 322. Denomination data 310 includes data that determines the denomination or denominations that the gaming machine uses to determine the amount of a wager. For example, a gaming machine may accept payment for credits in units of $.25, $.50, $1.00, $5.00 or other amounts. In addition, denomination data 310 also determines the currency for the wagered amount. For example, the currency may be United States dollars, French francs, Euros or other currency.

Pay table 312 may be used to determine which outcomes are winning outcomes and the amount to be credited or paid out for the various winning outcomes. Pay table 312 may be a single table in some embodiments. In alternative embodiments, multiple pay tables may be present on a gaming machine and vary depending on which game or game version is currently in use.

Language data 314 comprises one or more data sets or files that contain text to be displayed on the gaming machine. The use of language data 314 allows a wagering game application to display text in the language common the location where the gaming machine is used without requiring customization of the wagering game application.

Video content 316 comprises video data that may be displayed by wagering game application during the course of wagering game play or in an attract mode of the gaming machine. For example, video content may comprise video clips that are displayed to the user during game play, during a bonus round, or while the gaming machine is in attract mode.

Audio content 318 comprises audio data that may be played by the wagering game application during the course of wagering game play, bonus round play, or in an attract mode of the gaming machine. In some embodiments, the audio content may be part of an audio program played on multiple gaming machines to produce a surround-sound effect.

In some embodiments, a portion of video content 316 or audio content 318 may be provided by a gaming establishment and played during game play or in attract mode. This allows the gaming establishment to tailor a gaming machine for their environment. For example, the gaming establishment may desire to provide video or audio content having a theme that is consistent with a theme within the gaming establishment as a whole.

Episode data 320 provides configuration data regarding episodes for a game. In some embodiments, the wagering game may be presented to the user in episodes. For example, bonus rounds may vary depending on the episode, or symbols and characters displayed during game play or game play rules may vary with each episode. Additionally, in some embodiments, some or all of video content 316 and audio content 318 may vary depending on the current episode. Episode data 320 may be used to determine which episode is currently presented to the user.

Configuration data 322 represents other types of configuration data related to the operation of a gaming machine or a group of gaming machines. Examples of such data include the uses for buttons present on the gaming machine.

In addition to wagering game application related configuration elements, a gaming machine may have other types of configuration components. In some embodiments, these components include security data 304, banner content 306 and advertising content 308. Security data 304 may be any type of security data related to the operation of a gaming machine or group of gaming machines. In some embodiments, the security data comprises user identification and/or password data. In alternative embodiments, the security data may comprise public key/private key encryption data. In further alternative embodiments, the security data may comprise key ring data for a group of keys. In still further embodiments, the security data may comprise biometric data. Additionally, the security data may comprise authentication and/or authorization data.

Banner content 306 comprises content intended to be displayed on a secondary display or overhead sign for a gaming machine. The banner content may be displayed on a single gaming machine, or it may be content designed to be displayed as part of the content for multiple gaming machines. For example, the content may be displayed in a manner such that the content appears to travel from one machine to the next. Alternatively, the content may be one portion of a message that is displayed across multiple gaming machines.

Advertising content 308 comprises advertising video, audio, or text data that may be played or displayed on a gaming machine.

Various combinations of the above-described configuration elements may be downloaded onto a gaming machine. It should be noted that no embodiment requires that all the above-described configuration elements be downloadable, rather varying embodiments will provide for the download of varying combinations of one or more of the above-described configuration elements.

Further, the above described configuration elements may be downloaded at different times. For example, it may be desirable to download wagering game applications components, operating system components, device driver components and the like when the machine is idle (i.e. not in use). However, other configuration elements such as episode data, banner content and advertising content may be downloaded at any time, including during wagering game play.

Additionally, some or all of the above-described configuration elements may have different versions. For example, the operating system 340, device driver 342, device firmware 350, or wagering game application 302 may exist in differing versions, with each version having differing combinations of features and/or updates to fix problems with previous versions. Typically a version will have a version identifier associated with it to indicate the software version for the configuration element.

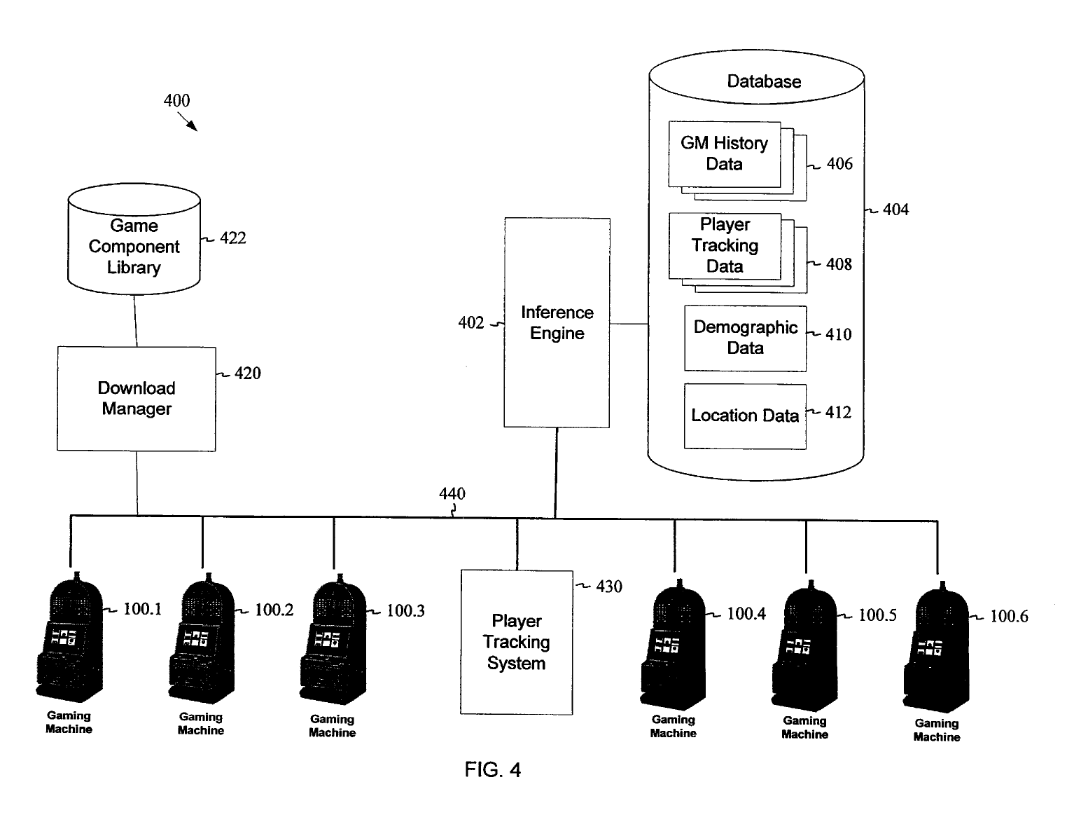

FIG. 4 illustrates various components of a gaming machine network 400 in which embodiments of the invention may be incorporated. In some embodiments, the gaming machine network includes inference engine 402, download manager 420 and gaming machines 100, all communicably coupled via network 440. Network 440 may be a wired or wireless network, or a combination of wired and wireless networks. In some embodiments, network 440 is a gaming establishment local area network. In alternative embodiments, network 440 may be a network that links multiple gaming establishments or facilities. In further alternative embodiments, network 440 may include the Internet.

In some embodiments, download manager 420 provides downloadable content to gaming machines 100. The downloadable content may comprise any combination of the components described above with reference to FIG. 3. In some embodiments, content may be pushed from download manager 420 to a gaming machine 100. In alternative embodiments, gaming machines 100 may pull content from download manager 420.

During the course of their operation, gaming machines 100 generate gaming machine history data. In general, the gaming machine history data may comprise various parameters relating the operation of the gaming machine such as games played, credits won/lost, attract mode types and durations, game episodes played, banner content types and durations, and other such operational data. Periodically, the gaming machines 100 send the gaming machine history data to inference engine 402. The gaming machines may push the data to the inference engine, or the inference engine may periodically pull the data from the gaming machines.

In some embodiments, inference engine 402 maintains a database 404 of the operational data received from gaming machines 100, and may also maintain data obtained from other systems such as player tracking system 430. Although shown as one entity for convenience, database 404 may be comprised of multiple databases. Further, database 404 may be a relational database, hierarchical database, object oriented database, XML database or a set of one or more files in a file system and combinations of the above. In some embodiments, database 404 may include gaming machine history data 406, player tracking data 408, demographic data 410, and location data 412.

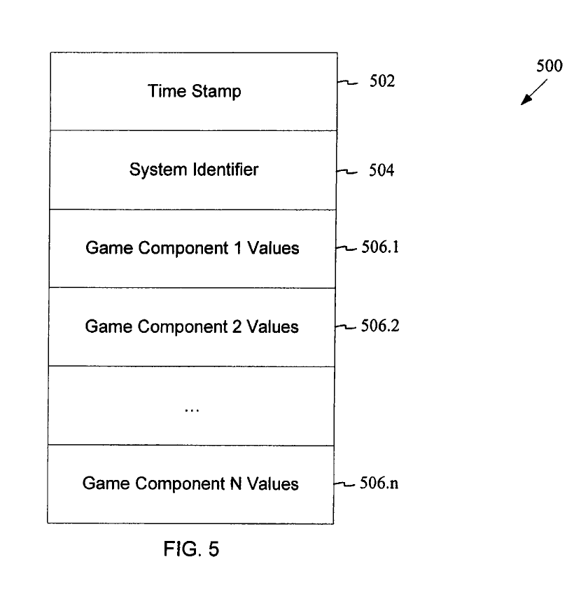

Gaming machine history data 406 comprises operational data received from gaming machines 100. Further details on the operational data are provided below with reference to FIG. 5.

Player tracking data 408 comprises data gathered regarding individual game players based on their insertion of a player tracking card or other player tracking device into a gaming machine's player tracking interface 124. Player tracking data 408 may include identification of the gaming machines the player has used, demographic information regarding the player, and game play preferences for the player. The player tracking data may be obtained from player tracking system 430.

Demographic data 410 may include data generated or aggregated based on player tracking data 408. In addition, demographic data 410 may include data received from game players in response to prompts displayed on a gamine machine 100.

Location data 412 includes data that indicates where gaming particular machines are located. The location data may include a particular casino or gaming establishment, a location on the floor of the establishment, a location in relation to other features of the establishment (e.g. near an outside door, near a bar, near an entertainment facility, or proximity to other gaming establishment features.

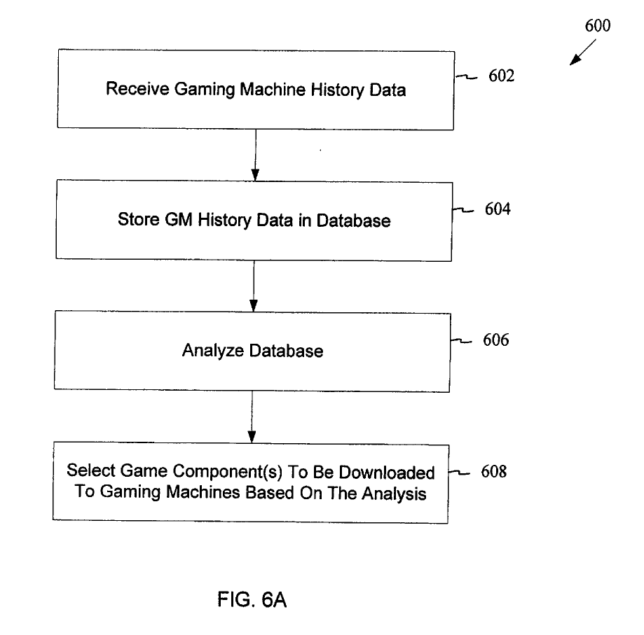

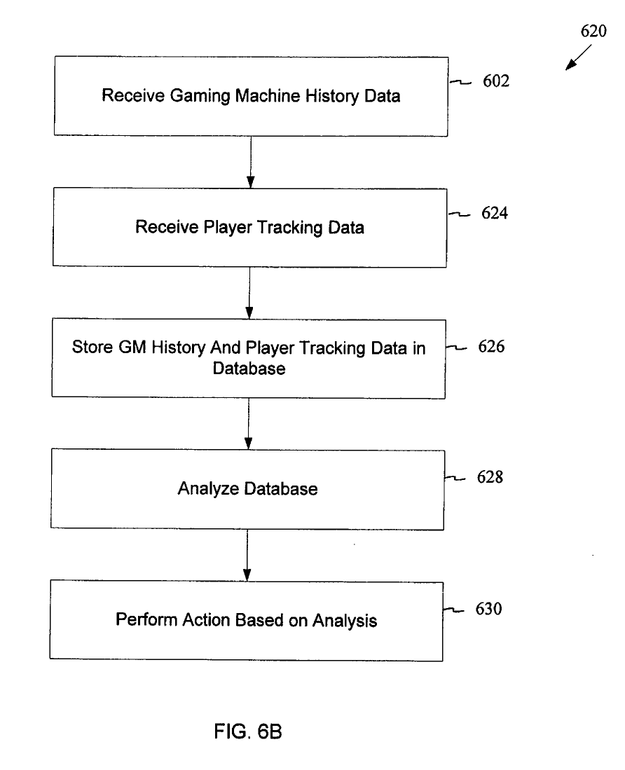

In operation, inference engine 402 analyzes the gaming machine history data 406 in order to determine which game components should be downloaded to a gaming machine, and may also determine a time for the download. Inference engine 402 may also use player tracking data 408, demographic data 410 and location data 412 as part of the analysis. In some embodiments, inference engine 402 applies a set of business rules in order to perform the analysis. The business rules may determine how the data is used to reach decisions regarding where and when to download game components to a gaming machine 100. Further details on the types of business rules that may be applied are described below with reference to FIGS. 6A and 6B.

In some embodiments, the determinations reached by inference engine 402 regarding where and when to download game components is communicated to download manager 420, which selects the desired game components from game library 422. The selected game components may then be downloaded, or scheduled for download to the selected gaming machines 100.

FIG. 4 has illustrated various logical components of a gaming system according to certain embodiments. It should be noted that in various embodiments, the functionality described in this application may be distributed across any number of system components, including server systems, gaming machines, and other system components.

FIG. 5 is a block diagram illustrating various elements of operational game history data according to various embodiments of the invention. In some embodiments, the game history data includes a time stamp 502, system identifier 504, and one or more game component values 506. Time stamp 502 provides a date and time that the data was obtained and/or transmitted to inference engine 402. System identification value 504 comprised an identifier that identifies the gaming machine that supplies the data. The identifier may be a serial number for the machine, a MAC (Media Access Control) address, a network address, or any other identifier that can be used to uniquely identify the gaming machine. Game component values 506 comprise the various operational parameters that may be reported for use by inference engine 402. Examples of such data include various combinations of one or more of the following:
Frequency and/or durations of game play
Frequency and/or duration of bonus round play
Frequency and/or duration of episode play
Counts of side bets executed during game play
Credit amounts won, lost and/or available
Frequency and/or duration of attract mode sessions
Frequency and/or duration of banner content display
Frequency and/or type of customer service requests (drinks, food, “comps” etc.)
Frequency and/or duration of advertising content
   The above set of operational data is one example, other types of operational data are possible and within the scope of the inventive subject matter. Combinations of one or more of the above elements may be reported to inference engine 402 during an update period.

FIGS. 6A and 6B are methods for managing download of game components to gaming machines. The methods to be performed by the operating environment constitute computer programs made up of computer-executable instructions. Describing the methods by reference to a flowchart enables one skilled in the art to develop such programs including such instructions to carry out the method on suitable processors for gaming machines (the processor or processors of the computer executing the instructions from computer-readable media). The methods illustrated in FIGS. 6A and 6B are inclusive of acts that may be taken by an operating environment executing an exemplary embodiment of the invention.

FIG. 6A illustrates a method 600 for managing download of game components to one or more gaming machines according to various embodiments of the invention. The method begins by receiving gaming machine history data from one or more gaming machines (block 602). The gaming machine history data may comprise the data described above with reference to FIG. 5. The gaming machine history data may be pushed by the gaming machines, or pulled from the gaming machines at periodic intervals. The data may then be stored in a database (block 604).

Next, the system analyzes the database (block 606). Various types and combinations of analysis may be performed. For example, statistical analysis may be performed to discover trends regarding game component activity. For example, certain games, bonus rounds, or episodes may be becoming more popular while other games, bonus rounds or episodes may be becoming less popular. In addition, heuristics and business rules may be applied to discover relationships in the data. Examples of such relationships include:
game title and user demographics (e.g. male player aged 50 and over prefer game A, while female player age 30 and below prefer game B)
game title and other game titles (e.g. player that like game A also like game B)
demographics and game location (players age 50 and over prefer to be near a restaurant while players age 30 and younger prefer to be near an entertainment venue)
game play and time of day, day of week, day of year, holidays etc.
game configurations and demographics (e.g. button configuration, menus, icons, color schemes, audio type and/or volume, video display etc. and player sex or age)
game play duration and level of difficulty (e.g. an episode that takes a long time to play may be a difficult episode)
game play duration and popularity (e.g. a game that is played frequently but for short periods may be considered boring to players, while games that are played less frequently and for longer periods may be considered popular or interesting)
game play duration and win/loss patterns (e.g. games where the pay table typically provides for small losses with infrequent big wins may be more popular than games where losses are larger, but wins are more frequent and smaller)
game play duration and game denomination (e.g. games having certain denominations may be more popular than games having other denominations)
   Those of skill in the art will appreciate that other relationships are possible and within the scope of the inventive subject matter. Further, relationships of varying complexity levels may be analyzed and discovered. For example, three-way, four-way or n-way relationships may be analyzed and discovered depending on the processing resources and configuration of inference engine 402. Further details on method to perform the analysis used in some embodiments may be found in United States Patent Application publication number 2004/0166940 entitled “Configuration of Gaming Machines” and published Aug. 26, 2004, which has been previously incorporated by reference.

Next, the system selects a game component to be downloaded to a gaming machine based on the analysis of the database (block 608). For example, if the analysis reveals that male player age 50 and over prefer to be near a restaurant and that male player age 50 and over prefer game “A”, then the system may select game “A” for download to gaming machines near a restaurant. Other examples include downloading a more popular denomination component, downloading a more popular pay table, etc.

FIG. 6B illustrates a method 620 for managing the operation of a gaming machine according to various embodiments of the invention. The method begins by receiving game history data (block 602). In addition, the system receives player tracking data (block 624). The player tracking data and the game history data may be stored in a database (block 626).

Next, the system analyzes the database (block 628). As with block 606, various types and combinations of analysis may be performed but here the analysis may be more focused on a particular player. For example, certain games, bonus rounds, or episodes may be becoming more popular with a particular player while other games, bonus rounds or episodes may be becoming less popular. In addition, heuristics and business rules may be applied to discover relationships in the data with respect to the player.

The system may then perform an action or cause an action to be performed based on the analysis (block 630). Examples of such actions include:
Downloading games that are popular with the player
Downloading button, user interface and other configuration elements that are popular with the user.
Suggesting games that the user may enjoy based on a comparison of the user's demographic information with games that are popular with other user having the same demographic characteristics
Providing services such as e-mail, instant messaging or other services on the gaming machine based on a the players wagering history
Display a map of the locations of preferred and/or suggested games in the gaming establishment
Reserve a preferred game (as determined by the game history and player tracking data) or suggested gaming machine for the player for a limited amount of time.
Invite the player to participate in a focus group regarding gaming issues or to try a new game.
   The actions listed above are examples of possible actions. Those of skill in the art will appreciate that other types of actions are possible and within the scope of the inventive subject matter.

In addition, some of the actions may or may not be performed based on a gaming establishment's perceived player “worth” (e.g. revenue attributable to the player gaming activities). Additionally, certain actions such as reserving downloadable games may or may not be performed depending on the current occupancy of the gaming establishment, the current time of day, day of week or time of year etc.

### CONCLUSION

Systems and methods for performing data mining to determine what game components should be downloaded to particular gaming machines in a network of gaming machines have been described. Although specific embodiments have been illustrated and described herein, it will be appreciated by those of ordinary skill in the art that any arrangement which is calculated to achieve the same purpose may be substituted for the specific embodiments shown. For example, the data mining download methods described above were provided in the context of updating one or more gaming machines. The systems and method may also be used to update configuration elements on other devices on a gaming network. For example, auxiliary servers such as progressive servers, overhead sign controllers and other devices may be administered in the same manner as described above. This application is intended to cover any adaptations or variations of the inventive subject matter.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method for managing downloadable content for a network of gaming machines, the method comprising:
receiving gaming machine history data from one or more gaming machines, the gaming machines operable to present a gaming application on which monetary value may be wagered;
storing the gaming machine history data in a database;
analyzing the database; and
selecting a game component to be downloaded to a gaming machine based on the analysis of the database.

2. The method of claim 1, wherein analyzing the database includes:
determining an operation value for a set of one or more candidate game components;
selecting for download the game component from the candidate game components according to the operation value.

3. The method of claim 2, wherein the operation value comprises an operation time.

4. The method of claim 2, wherein the operation value comprises an operation count.

5. The method of claim 2, wherein analyzing the database further includes determining a time value associated with the operation value and wherein the game component is selected according to the operation value and the time value.

6. The method of claim 5, wherein the time value includes a time value selected from the group consisting of: time of day, day of week, day of year and holiday type.

7. The method of claim 2, wherein analyzing the database further includes determining a location value associated with the operation value and wherein the game component is selected according to the operation value and the location value.

8. The method of claim 1, wherein the game component includes a component selected from the group consisting of banner content, advertising content, denomination, pay table, language data, video content, audio content, episodic game data, and wagering game software.

9. A method for managing downloadable content for a network of gaming machines, the method comprising:
receiving player tracking data;
receiving gaming machine history data;
storing the player tracking data and the gaming machine history data in a database;
analyzing the database; and
performing an action based on the analysis of the database.

10. The method of claim 9, wherein the action comprises displaying a set of related games.

11. The method of claim 10, wherein the action comprises displaying a map indicating the location of the set of related games.

12. The method of claim 9, wherein the action comprises displaying one or more suggested games.

13. The method of claim 9, wherein the action comprises reserving a gaming machine.

14. The method of claim 9, wherein the action comprises downloading a game component to a gaming machine based on the presence of a player tracking identification.

15. A gaming system comprising:
a set of one or more gaming machines communicably coupled to a network, the gaming machines operable to present a gaming application on which monetary value may be wagered and further operable to generate game history data;
an inference engine communicably coupled to the network and operable to:
receive the game history data;
store the game history data in a database;
analyze the database; and
select a game component according to the analysis; and
a download manager operable to download the selected game component to a gaming machine of the set of one or more gaming machines.

16. The gaming system of claim 15, wherein the game component includes a component selected from the group consisting of banner content, advertising content, denomination, pay table, language data, video content, audio content, episodic game data, and wagering game software.

17. The gaming system of claim 15, further comprising a player tracking system operable to maintain player tracking data and wherein the player tracking data is stored in the database.

18. The gaming system of claim 15, wherein the database stores location data for the gaming machines.

19. A computer-readable medium having computer executable instructions for performing a method for managing downloadable content for a network of gaming machines, the method comprising:
receiving gaming machine history data from one or more gaming machines;
storing the gaming machine history data in a database;
analyzing the database; and
selecting a game component to be downloaded to a gaming machine based on the analysis of the database.

20. A computer-readable medium having computer executable instructions for performing a method for managing downloadable content for a network of gaming machines, the method comprising:
receiving player tracking data;
receiving gaming machine history data;
storing the player tracking data and the gaming machine history data in a database;
analyzing the database; and
performing an action based on the analysis of the database.
